(19) United States
(12) Patent Application Publication
(10) Pub. No.: US 2026/0042272 A1
(43) Pub. Date: Feb. 12, 2026

(54) POST-CRUMPLER JAM DETECTOR FOR DUNNAGE DEVICE

(71) Applicant: Pregis LLC, Chicago, IL (US)

(72) Inventors: Thomas D. Wetsch, Naples, FL (US); Ken Chess, Hinsdale, IL (US); David Joyce, Naperville, IL (US); Michael Marszalek, Bolingbrook, IL (US)

(21) Appl. No.: 19/295,465

(22) Filed: Aug. 8, 2025

Related U.S. Application Data
(60) Provisional application No. 63/681,757, filed on Aug. 9, 2024.

(51) Int. Cl. B31D 5/00

(52) U.S. Cl. CPC B31D 5/0052; B31D 2205/0058; B31D 2205/007; B31D 2205/0088; B31D 2205/0094

(57) ABSTRACT

A device for producing dunnage includes a jam detector located downstream of a crumpler and upstream of an outlet chute of the device and configured to detect a jam of the dunnage between the crumpler and the outlet chute.

### CROSS-REFERENCE TO RELATED APPLICATIONS

This application claims the benefit under 35 U.S.C. § 119 (e) of U.S. Provisional Patent Application No. 63/681,757, filed Aug. 9, 2024, the contents of which are incorporated by reference herein in their entirety.

### TECHNICAL FIELD

The present disclosure relates to devices that convert paper stock and other materials into dunnage for use as packing material, and more specifically, to the detection of jams in devices for producing dunnage.

### BACKGROUND

Paper-based protective packaging in the form of dunnage is produced by crumpling or otherwise deforming paper stock. More specifically, paper dunnage is produced by running a generally continuous strip of paper through a dunnage machine. The continuous strip of paper can be provided, for example, from a roll of paper or a fanfold stack of paper. The dunnage machine converts the stock material into a lower density dunnage material using, for example, opposing rollers between which the stock material is passed. The rollers grip and pull the stock material from the roll or stack, and deform the stock material as the material passes between the rollers. The resulting dunnage can be cut into desired lengths to effectively fill a void space within a container holding a product. The dunnage material may be produced on an as-needed basis for an individual or a machine performing packing operations.

The ability to smoothly and continuously feed the paper stock from the stack or roll is important to the proper and efficient operation of the dunnage machine. Jamming and other interruptions in the flow of paper stock supplied to the dunnage machine can prevent the machine from producing dunnage at the required rate, which in turn can cause delays in packaging and shipping operations that rely on a ready supply of dunnage. Frequent jamming also can result in damage to the dunnage machine, and increased maintenance costs.

### SUMMARY OF THE INVENTION

In one aspect of the disclosed technology, a device for producing dunnage includes an outlet chute configured to receive the dunnage and direct the dunnage to an exit of the device, and a drive assembly configured to deform a stock material into the dunnage and to drive the dunnage into and through the outlet chute to the exit.

The device also includes an upstream jam detector located along a material path of the dunnage between the drive assembly and the outlet chute and sensitive to detect a dunnage jam between the drive assembly and the outlet chute. The upstream jam detector is associated with the drive assembly to cause the drive assembly to stop driving the dunnage into and through the outlet chute upon detection of the dunnage jam between the drive assembly and the outlet chute.

In another aspect of the disclosed technology, the device further includes a controller operably connected to the drive assembly and the upstream jam detector. The controller is configured to control the driving of the dunnage.

In another aspect of the disclosed technology, the controller is configured to prohibit operation of the drive assembly upon detection of the dunnage jam between the drive assembly and the outlet chute is detected.

In another aspect of the disclosed technology, the controller is configured to prohibit operation of the drive assembly until the dunnage jam between the drive assembly and the outlet chute is cleared as detected by the upstream jam detector.

In another aspect of the disclosed technology, the device further includes a separator configured to separate a piece of the dunnage from a portion of the dunnage upstream of the separator, and the upstream jam detector is located upstream of the separator.

In another aspect of the disclosed technology, the separator includes a cutting mechanism configured to cut the piece of the dunnage from the portion of the dunnage upstream of the separator.

In another aspect of the disclosed technology, the separator is operatively connected to the controller, and the controller is configured to prohibit operation of the separator upon detection of the dunnage jam between the drive assembly and the outlet chute.

In another aspect of the disclosed technology, the controller is configured to prohibit operation of the separator until the dunnage jam between the drive assembly and the outlet chute is cleared as detected by the upstream jam detector.

In another aspect of the disclosed technology, the device further includes a downstream jam detector associated with the outlet chute and sensitive to detect a dunnage jam within the outlet chute. The downstream jam detector is further associated with the drive assembly to cause the drive assembly to stop driving the dunnage into and through the outlet chute upon detection of the dunnage jam within the outlet chute.

In another aspect of the disclosed technology, the device further includes a separator configured to separate a piece of the dunnage from a remainder of the dunnage. The upstream jam detector is located upstream of the separator and the downstream jam detector is located downstream of the separator. The upstream and downstream jam detectors are associated with the separator to cause the separator to stop separating the piece of the dunnage from the remainder of the dunnage upon detection of one or both of the dunnage jam between the drive assembly and the outlet chute and the dunnage jam within the outlet chute.

In another aspect of the disclosed technology, the controller is configured to prohibit operation of the drive assembly upon detection of the dunnage jam within the outlet chute.

In another aspect of the disclosed technology, the controller is configured to prohibit operation of the drive assembly until the dunnage jam within the outlet chute is cleared as detected by the downstream jam detector.

In another aspect of the disclosed technology, the upstream jam detector includes a movable member having a surface exposed to a path of the dunnage, such that accumulation of the dunnage caused by the dunnage jam between the drive assembly and the outlet chute depresses the surface so that the movable member actuates a switch and/or an electrical contact communicatively coupled to the controller.

In another aspect of the disclosed technology, the movable member is configured to deflect away from the material path in response to the accumulation of the dunnage.

In another aspect of the disclosed technology, the surface of the movable member is substantially planar.

In another aspect of the disclosed technology, the drive assembly includes a crumpler configured to deform the stock material into the dunnage.

In another aspect of the disclosed technology, the crumpler includes a roller.

In another aspect of the disclosed technology, the drive assembly further includes a guide configured to guide the dunnage at and near the roller.

In another aspect of the disclosed technology, the guide includes the movable member.

In another aspect of the disclosed technology, the roller is mounted for rotation on a shaft, and the guide is mounted on the shaft.

In another aspect of the disclosed technology, the roller is configured to translate linearly in a direction transverse to an axis of rotation thereof.

In another aspect of the disclosed technology, the roller is configured to translate linearly in the direction transverse to the axis of rotation thereof in response to accumulation of the dunnage caused by the dunnage jam between the drive assembly and the outlet chute.

In another aspect of the disclosed technology, a dunnage system includes a supply unit of stock material, and a supply station configured to hold the supply unit of stock material. The system includes a device for producing dunnage, including an outlet chute configured to receive the dunnage and direct the dunnage to an exit of the device, and a drive assembly configured to deform a stock material into the dunnage and to drive the dunnage into and through the outlet chute to the exit.

The device also includes an upstream jam detector located along a material path of the dunnage between the drive assembly and the outlet chute and sensitive to detect a dunnage jam between the drive assembly and the outlet chute. The upstream jam detector is associated with the drive assembly to cause the drive assembly to stop driving the dunnage into and through the outlet chute upon detection of the dunnage jam between the drive assembly and the outlet chute.

In another aspect of the disclosed technology, the device further includes a controller operably connected to the drive assembly and the upstream jam detector and configured to prohibit operation of the drive assembly upon detection of the dunnage jam between the drive assembly and the outlet chute, and a separator operably connected to the drive assembly and configured to separate a piece of the dunnage from a remainder of the dunnage. The controller is configured to prohibit operation of the separator upon detection of the dunnage jam between the drive assembly and the outlet chute.

In another aspect of the disclosed technology, the device further includes a downstream jam detector associated with the outlet chute and sensitive to detect a dunnage jam within the outlet chute. The downstream jam detector is associated with the drive assembly to cause the drive assembly to stop driving the dunnage into and through the outlet chute upon detection of the jam within the outlet chute.

In another aspect of the disclosed technology, the stock material is paper.

In another aspect of the disclosed technology, a device for producing dunnage includes an outlet chute configured to receive the dunnage and direct the dunnage to an exit of the device, and a drive assembly configured to deform a stock material into the dunnage and to drive the dunnage into and through the outlet chute to the exit.

The device also includes an upstream jam detector located along a material path of the dunnage between the drive assembly and the outlet chute and sensitive to detect a dunnage jam between the drive assembly and the outlet chute. The upstream jam detector is associated with the drive assembly to cause the drive assembly to stop driving the dunnage into and through the outlet chute upon detection of the dunnage jam between the drive assembly and the outlet chute.

The device also includes a downstream jam detector associated with the outlet chute and sensitive to detect a dunnage jam within the outlet chute. The downstream jam detector also is associated with the drive assembly to cause the drive assembly to stop driving the dunnage into and through the outlet chute upon detection of the dunnage jam within the outlet chute.

In another aspect of the disclosed technology, a method for operating a device for producing dunnage includes activating a drive assembly of the device to deform a stock material into the dunnage and to drive the dunnage into and through an outlet chute of the device to an exit of the device, deactivating the drive assembly in response to a dunnage jam between the drive assembly and the outlet chute, and preventing re-activation of the drive assembly until the dunnage jam is cleared.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a top-front perspective view of a system for producing dunnage.

FIG. 2 is a top-front perspective view of a dunnage machine of the system shown in FIG. 1, with the enclosure and an outlet chute of the dunnage machine removed.

FIG. 3 is a top-front perspective view of the dunnage machine shown in FIG. 2, with the enclosure, the outlet chute, a cutting motor assembly, and a cover of the dunnage machine removed.

FIG. 4 is a front view of the dunnage machine shown in FIGS. 1-3, with the enclosure, the outlet chute, the cutting motor assembly, and the cover of the dunnage machine removed, and depicting the cutting mechanism in a home position.

FIG. 5 is a front view of the dunnage machine shown in FIGS. 1-4, with the enclosure, the outlet chute, the cutting motor assembly, and the cover of the dunnage machine removed, and depicting the cutting mechanism in an intermediate position.

FIG. 6 is a front view of the dunnage machine shown in FIGS. 1-5, with the enclosure, the outlet chute, the cutting motor assembly, and the cover of the dunnage machine removed, and depicting the cutting mechanism in an end position.

FIG. 7 is a top cross-sectional view of the system shown in FIG. 1, taken through the line “VII-VII” of FIG. 16, depicting an actuator of an upstream jam detection device and a flap of a downstream jam detection device in deactivated states, indicative of the absence of a paper jam between rollers and a cutting mechanism and within the outlet chute.

FIG. 8 is a top cross-sectional view of the system shown in FIG. 1, taken through the line “VII-VII” of FIG. 16, depicting the actuator of the upstream jam detection device and the flap of the downstream jam detection device in activated states, indicative of the presence of a paper jam between the rollers and the cutting mechanism and within the outlet chute.

FIG. 9 is a top cross-sectional view of the system shown in FIG. 1, taken through the line “VII-VII” of FIG. 16, depicting the actuator of the upstream jam detection device in an activated state and the flap of the downstream jam detection device in a deactivated state, indicative of the presence of a paper jam between the rollers and the cutting mechanism.

FIG. 10 is a top cross-sectional view of the system shown in FIG. 1, taken through the line “VII-VII” of FIG. 16, depicting the actuator of an upstream jam detection device and the flap of the downstream jam detection device in deactivated states, indicative of the absence of a paper jam between the rollers and the cutting mechanism and within the outlet chute, and a translation of a roller within the dunnage machine.

FIG. 11 is a perspective view of a flap of the paper jam detection device shown in FIGS. 7-10, depicting an upstream edge and a back surface of the flap.

FIG. 12 is a perspective view of the flap shown in FIG. 11, depicting the upstream edge and an inward-facing surface of the flap.

FIG. 13 is a perspective view of an outlet chute of the system shown in FIG. 1, depicting an upstream end of the outlet chute.

FIG. 14 is a perspective view of system shown in FIG. 1, taken from a perspective downstream of the system and with the outlet chute removed, depicting a gate of the outlet chute in a closed position and the flap in the inward position.

FIG. 15 is a perspective view of system shown in FIGS. 1 and 13, taken from a perspective downstream of the system and depicting an interior of the outlet chute.

FIG. 16 is a side perspective view of the system shown in FIGS. 1, 13, and 15, taken through the line “XVI-XVI” of FIG. 8 and depicting the gate of the outlet chute in a closed position and with the dunnage material removed for clarity.

FIG. 17 is a side perspective view of the system shown in FIGS. 1, 13, and 15, taken through the line “XVI-XVI” of FIG. 8 and depicting the gate of the outlet chute in an open position and a holding a piece of dunnage in an unjammed state for clarity.

FIG. 18 is a cross-sectional view of the system shown in FIGS. 1 and 14-17, taken through the line “XVII-XVII” of FIG. 8.

FIG. 19 is a perspective view an embodiment of the upstream jam detection device.

FIG. 20 is an alternative perspective view of the embodiment of the upstream jam detection device of FIG. 19.

FIG. 21 is a block diagram depicting various electrical and electronic components of the system for producing dunnage shown in FIG. 1.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

Systems for converting a high-density stock material into low-density dunnage are disclosed. The stock material can be processed by longitudinal crumple machines that form creases longitudinally in the stock material to form dunnage, or by cross crimple machines that forms creases transversely across the stock material. The supply unit of stock material can be stored in a roll (whether drawn from inside or outside the roll), a wind, a fan-folded source, or other suitable form. The stock material can be continuous or perforated. The conversion apparatus is fed the stock material from the supply unit in a first direction, which can be an anti-run out direction.

The stock material can be any suitable type of protective packaging material including, for example, flat or rolled paper stock, other dunnage and void fill materials, inflatable packaging pillows, etc. Some embodiments can use supplies of other paper or fiber-based materials in sheet form. Other embodiments can use supplies of wound fiber material such as ropes or thread. Other embodiments can use thermoplastic materials such as a web of plastic material usable to form pillow packaging material. Examples of paper used include a fan-folded supply unit having stock material with 30-inch transverse widths and/or 15-inch transverse widths. Preferably these sheets are fan folded as single layers. In other embodiments, the multiple layers of sheets can be fan folded together such that dunnage is made of superimposed sheets that are crumpled together in the conversion process.

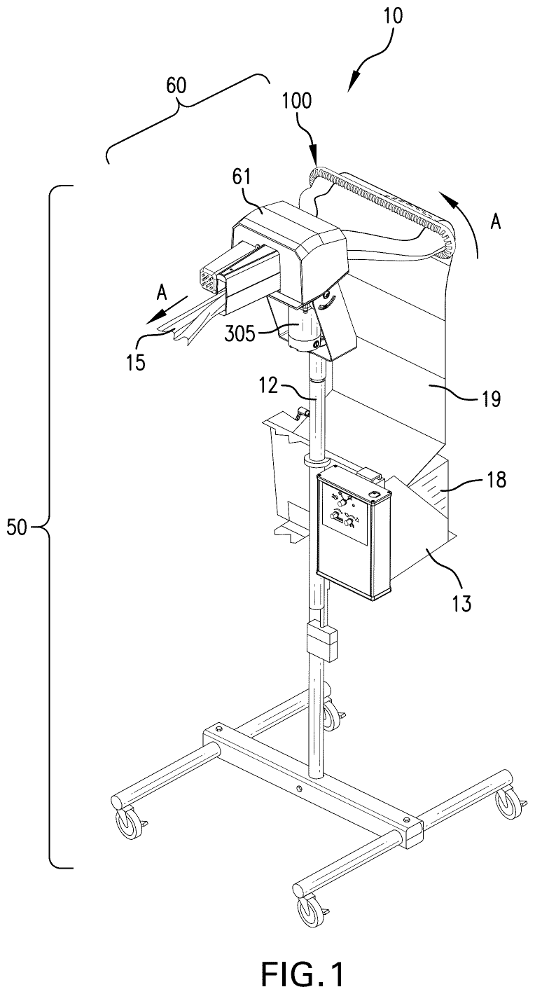

Any suitable stock material may be used. For example, the stock material can have a basis weight of about 20 lbs. to about 100 lbs. The stock material may comprise paper stock stored in a high-density configuration having a first longitudinal end and a second longitudinal end, that is later converted into a low-density configuration by the dunnage system. The stock material can be a ribbon of sheet material that is stored in a fan-fold structure as shown in FIG. 1; or in coreless rolls (not shown). The stock material can be formed or stored as single-ply or multiple plies of material. Where multi-ply material is used, a layer can include multiple plies. Other types of material can be used, such as pulp-based virgin and recycled papers, newsprint, cellulose and starch compositions, and poly or synthetic material, of suitable thickness, weight, and dimensions.

In some embodiments, the supply units of stock material may have fan-fold configurations. For example, a foldable material, such as paper, may be folded repeatedly to form a stack or a three-dimensional body. The term “three-dimensional body,” in contrast to the “two-dimensional” material, has three dimensions all of which are non-negligible. A continuous sheet, e.g., a sheet of paper, plastic, or foil, can be folded at multiple fold lines that extend transversely to a longitudinal direction of the continuous sheet, or transversely to the feed direction of the sheet. For example, folding a continuous sheet that has a substantially uniform width along transverse fold lines can form or define sheet sections that have approximately the same width. The continuous sheet can be folded sequentially, in opposite or alternating directions, to produce an accordion-shaped continuous sheet. For example, the folds may form or define sections along the continuous sheet, and the sections may be substantially rectangular.

A device 10 for producing dunnage is configured to process stock material 19 into dunnage 15. Referring to FIG. 1, the device 10 includes a supply unit 18 of the stock material 19, and a dunnage apparatus 50.

The dunnage apparatus 50 includes an upstream jam detector 700 for detecting paper jams upstream of an outlet chute 62 of the dunnage apparatus 50, and a downstream jam detector 400 for detecting paper jams within the outlet chute 62. The jam detector 700 and the jam detector 400 are described in connection with the supply unit 18 and the dunnage apparatus 50 for illustrative purposes only. The jam detector 700 and the jam detector 400 can be used in connection with dunnage apparatus having configurations different than that of the dunnage apparatus 50, and supply units 18 having configurations different than that of the supply unit 18.

The dunnage apparatus 50 also includes a dunnage mechanism 60; a support 12 configured to support the dunnage mechanism 60; and a supply station 13 configured to hold the supply unit 18 of stock material 19.

The specific configuration of the support 12 depicted in the figures is disclosed for illustrative purposes only. The support 12 can have other configurations suitable for supporting the dunnage mechanism 60.

Likewise, the shelf or basket-type configuration of the supply station 13 depicted in FIG. 1, which accommodates a supply unit 18 in the form of a stack of folded stock material 19, is disclosed for illustrative purposes only. The supply station 13 can have other configurations suitable for supporting the supply unit(s) 18 in single bundles; in multiple daisy chained bundles; in a flat configuration; in a rolled configuration; and/or in a curved configuration.

The supply station 13 can support one or more of the supply units 18 of stock material 19. In applications where multiple supply units 18 are accommodated by the supply station 13, the end and beginning sheets of adjacent supply units 18 can be connected together before or after being placed on the supply station 13. Connecting together or daisy-chaining multiple supply units can produce a continuous supply of stock material 19.

The stock material 19 is converted to the dunnage 15 as it follows a material path A through the device 10. The material path is denoted in FIG. 1. The material path A has an inlet end where the stock material 19 is fed into an upstream end the device 10, and an outlet end where the dunnage 15 exits the device 10 at a downstream end of the device 10.

Protective packaging articles are configured for placement within a packaging container or between packaging containers or items being shipped or stored, to protect items, fill void space within a container, such as a packaging container, and/or prevent or inhibit the items from moving around within the container. While there is overlap between the following categories, example categories of protective packaging articles include protective-fill articles, and block-and-brace articles.

Protective-fill articles are typically provided individually or as a plurality of units that are configured for placing into the void space to provide a desired level of packaging. Such units typically are of a predetermined size or can have a predetermined dimensions and be selectively configurable in another dimension, such as length. In some examples, the size of the protective-fill articles can be configurable in a plurality or all of their dimensions. Protective-fill articles are typically resiliently compressible to around corners, edges, and sides of a packaged item to fill the space around the item, instead of assuming a solid shape that corresponds to the space around the item. Protective-fill articles include, for example, void-fill articles and cushioning articles.

Void-fill articles typically provide minimal cushioning properties and are relatively soft. They are typically used to fill empty void space in packaging containers to reduce the movement within the container of lightweight items that are not delicate, such as a thin book. An example of void-fill includes crumpled-paper dunnage with a fairly weak loft pattern and other space fillers that are easily compressible.

Cushioning articles are configured to provide cushioning to the packaged items and protection to various degrees against shocks and impact. Examples of cushioning materials include inflatable air pillows and cushions, bubble wrap, paper dunnage with a loft structure capable of withstanding moderate shocks and impact, foam sheets, and packing peanuts.

Typically, both void-fill and cushioning articles are provided as a plurality of units of one or more similar sizes, typically common predetermined sizes, although in some applications the void-fill or cushioning articles can be made to custom sizes. Some cushioning articles are also packaging containers, such as padded mailers or other containers with a padded wall.

The plurality of void-fill or cushioning articles that are used is typically selected to sufficiently fill the void space within the container to serve the desired protective function. Some void-fill or cushioning articles can be used to enclose or otherwise surround an item, such as expandable-paper or bubble wrap that can be used to wrap an item, such as a bottle.

Block-and-brace articles are configured to restrain packaged items from substantial movement in relation to the packaging container and often provide the highest level of protective cushioning and impact resistance and are typically configured in association with the container, typically a box, to stabilize the item within the container and minimize or prevent its movement.

Block-and-brace articles tend to be used with heavy and/or delicate bulky items to protect them against breakage during shipping. Some block-and-brace articles are formed around an item being packaged within void space in a container, others are pre-formed to receive or fit against the packaged item and to fit precisely within the container to prevent movement of the item, and others are folded or shaped prior to insertion of the item into the container. Examples of block-and-brace articles are foam-in-place or foam-in-bag articles, which are typically formed by mixing foam precursors and injecting the mixture into flexible bags, such as made of poly film; the filled bags are placed in the box or other container with the item, and the precursor mixture foams to several hundred times its original size, filling the void between the item and the container, and then solidifying into a custom shape. Other examples include molded foam blocks, such as polystyrene, or cardboard forms that conform to the shape of the packaged item and the container. Block and brace also can include paper block and brace articles that with an elevated stiffness; these are often formed by multiple plies of paper and are produced to lock in fold or other shape in the paper that provides loft.

Block-and-brace typically receives and traps corner, edge, or other surface of the item within the box. Block and brace is typically used to protect heavy and delicate item during shipping, such as a large television set or an automobile clutch.

Protective articles that include an amount of padding, such as void-fill, cushioning, and block-and-brace, can be provided in their operable configuration, or can be provided in a high-density configuration and then expanded, such as a customer site, to a low-density configuration that provides the requisite amount of padding or thermal insulation. Examples of expandable materials and construction for the expandable articles include inflatable films and webs, paper that is crumpled or manipulated by a device to crease the paper to maintain loft, and chemical foams.

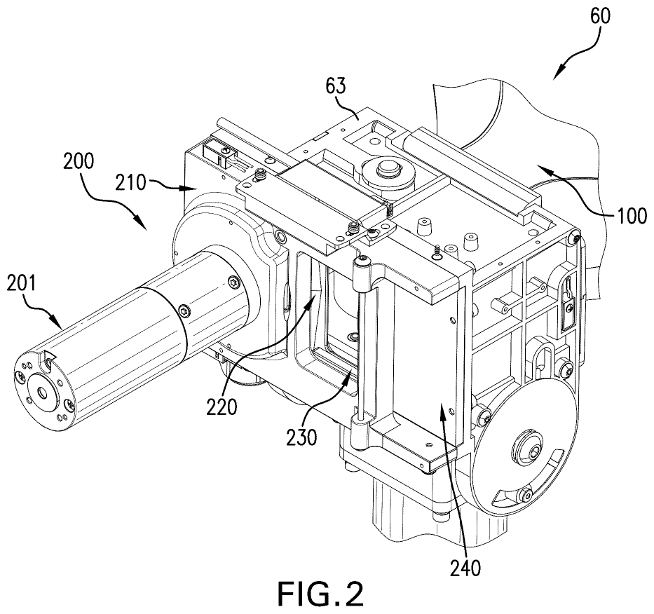

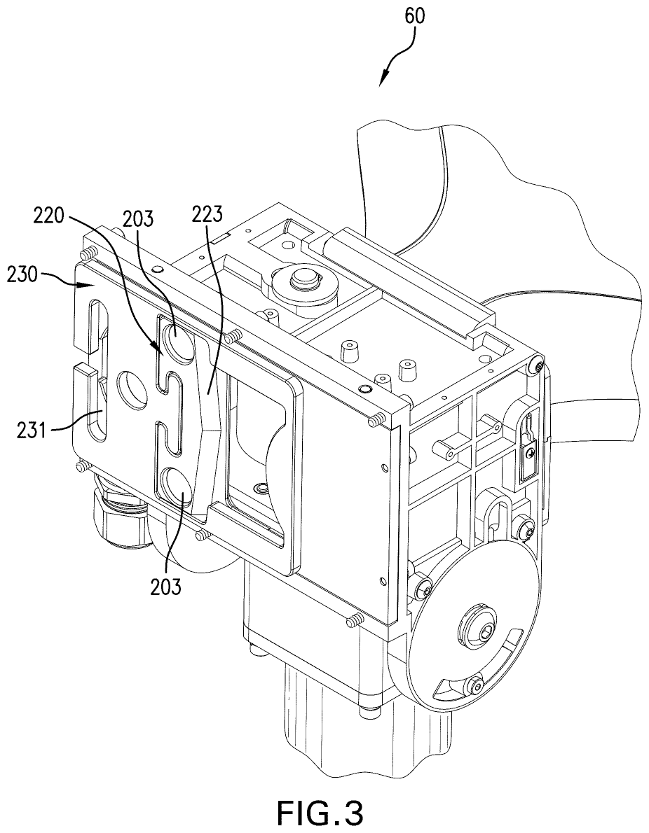

The dunnage mechanism 60 includes an enclosure 61, an intake 100; a cutting mechanism 200; and a feed motor 305. For purposes of illustration, FIGS. 2 and 3 depict the dunnage mechanism 60 without the enclosure 61, thus exposing a frame 63, and separator in the form of a cutting mechanism 200 of the dunnage mechanism 60. The intake 100 is rotatably coupled to the frame 63 through an inlet spindle (not shown). The intake 100 can be rotated upward about the inlet spindle, from a closed or lowered position (not shown), to a raised or open position shown in FIG. 1. The ability to rotate the intake 100 upward in this manner allows a user to clear material that may be jammed in or otherwise obstructing the exit portion of the intake 100.

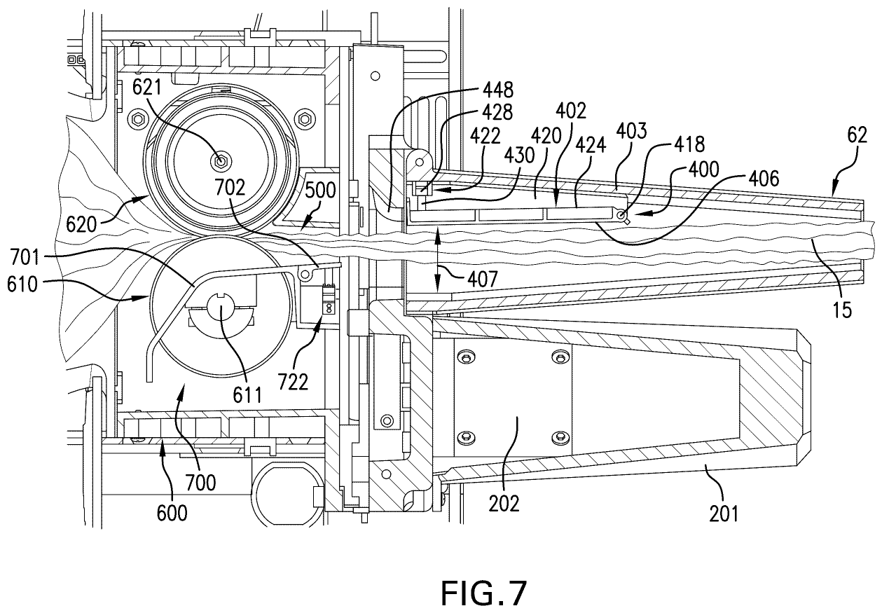

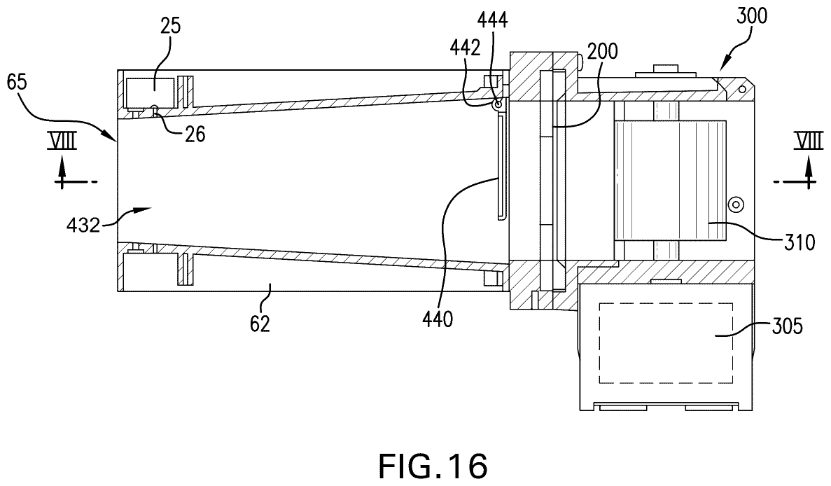

The dunnage mechanism 60 also includes a drive assembly 600, visible in FIGS. 7-10. The drive assembly 600 includes the feed motor 305 (shown in FIG. 1 and shown schematically in FIG. 16), and crumplers in the form of rollers 610, 620. The rollers 610, 620 are configured to drive the stock material 19 through the dunnage mechanism 60, convert the stock material 19 into dunnage 15, and push the dunnage 15 into the outlet chute 62. Other types of crumplers can be used in lieu of the rollers 610, 620 in alternative embodiments.

The intake 100 includes a guide having an inlet end for receiving the stock material 19 from the supply unit 18, and an outlet end through which the stock material 19 passes as it exits the intake 100 while traveling within and through the intake 100 along a portion of the material path A. The jam detection device 700 can be used as part of dunnage devices having intakes with configurations different than that of the intake 100.

The rollers 610, 620 are depicted in FIGS. 7-10. The rollers 610, 620 are configured to compress and crumple the stock material 19 entering the dunnage mechanism 60, convert the stock material 19 into dunnage 15, and transport the dunnage 15 through, and out of the dunnage mechanism 60. In particular, the rollers 610, 620 are configured to pull the stock material 19 from the inlet supply 18 and through intake 100; crumple and otherwise deform the stock material 19 as it passes between the rollers 610, 620; and then push the newly-formed dunnage 15 downstream, through the cutting mechanism 200 and into the outlet chute 62. Details of the rollers 610, 620 are presented for illustrative purposes only. The jam detection device 700 can be used in conjunction with rollers having other configurations, and with dunnage machines that crumple and deform stock material 19 using techniques other than rollers.

The roller 620 is driven in rotation by the feed motor 305. The roller 610 is idle, i.e., the roller 610 is not driven by a motor. The roller 610 is biased toward the roller 620, and is driven to rotate by interaction with the rotating roller 620 via an outer surface of the roller 610. In alternative embodiments, the roller 610 can be driven by a motor of the drive assembly 600.

The outer surface of the roller 610 is substantially smooth. The roller 620 has a shape or profile different than that of the roller 610. For example, an outer surface of the roller 620 can have grooves formed thereon. The grooves receive toroid-shaped ridges (not shown).

During operation of the dunnage mechanism 60, the stock material 19 is drawn by, and between the rollers 610, 620, from the supply station 13 and via the intake 100. The ridges on the roller 620, and the opposing outer surface of the roller 610 exert a pressure against the stock material 19. The pressure crumples and otherwise deforms the stock material 19 and increases the volume of the stock material 19, converting the stock material 19 into the dunnage.

FIGS. 2 and 3 depict the cutting mechanism 200 of the dunnage mechanism 60, coupled to the frame 63. FIGS. 2 and 3 depict the dunnage mechanism 60 without the enclosure 61, for clarity of illustration. The cutting mechanism 200 includes a cutting motor assembly 201 having a cutting motor 202; a cover 210; a crank; a shuttle 230; magnets 203; a cutting portion 220; and an anvil portion 240.

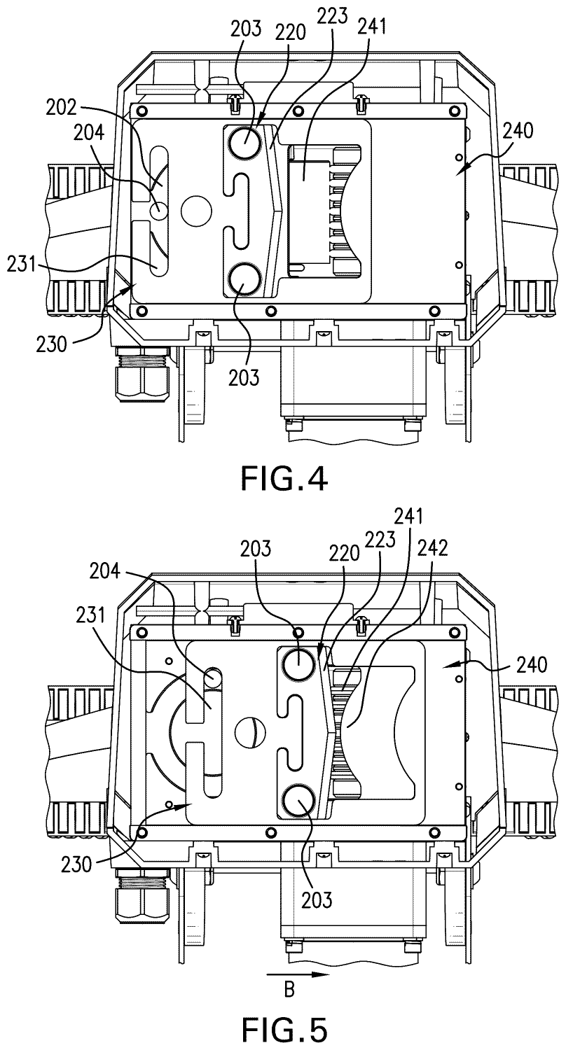

Depicted in FIGS. 4-6, the crank includes a crank arm 204 that is rotated by the cutting motor assembly 201. As can be seen in FIGS. 2-6, the shuttle 230 has a guide slot 231 formed therein and configured to receive an end portion of the crank arm 204, so that the crank arm 204 can translate between the ends of the guide slot 231 as the crank rotates. The engagement of the rotating crank arm 204 and the shuttle 230 imparts linear movement to the shuttle 230 in a cutting direction B.

The cover 210 defines a recess configured to receive the crank, and a space within the cover 210 to receive the shuttle 230. The shuttle 230 is configured to engage the cutting portion 220 so that movement of the shuttle 230 imparts a corresponding movement to the cutting portion 220.

The cutting portion 220 is held against the anvil portion 240, which is mounted on the frame 63 and remains stationary in relation to the cutting portion 220, by the magnets 203. The magnets 203 permit the cutting portion 220 to slide along the contacting surface of the anvil portion 240, in the cutting direction B.

The cutting portion 220 has a cutting edge 223. A leading end of the cutting edge 223 has a sharp tip that helps the cutting edge 223 to efficiently initiate a cut in the dunnage 15, and to center and pin the dunnage 15 so that the dunnage 15 does not become crowded to one side. Such crowding could cause the dunnage 15 to form a bundle, which in turn could make it difficult to cut the dunnage 15.

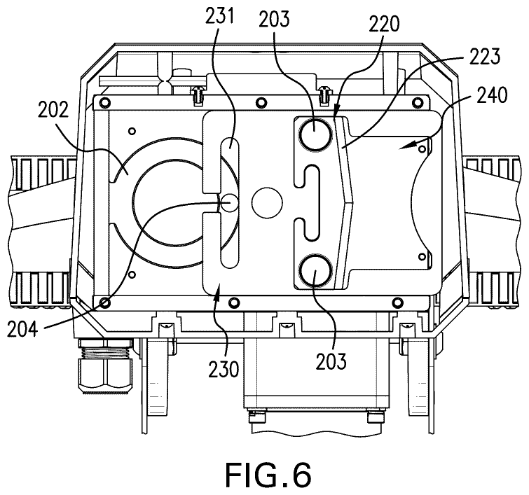

In the assembled state, the cutting portion 220 and the anvil 242 define a window 241 through which the dunnage 15 passes after being converted by the drive assembly 600. The dunnage passes through an area 500 before passing through the window 241 (see FIGS. 7-10). The window 241 is denoted in FIGS. 4-5. The cutting mechanism 200 can move from a home position (shown in FIGS. 3 and 4), through an intermediate position (without stopping) (shown in FIG. 5), and to end position (shown in FIG. 6), in response to rotation of the crank arm 204. In the home position, the cutting portion 220 is at the farthest distance from the anvil 242, and the window 241 is at its largest size. As the cutting mechanism 200 moves toward, and past its intermediate position and the cutting portion 220 moves in the cutting direction B, the window 241 decreases in size. When dunnage 15 is located within the window 241, as during normal operation of dunnage mechanism 60, the cutting edge 223 initiates a cut to the dunnage 15 when the cutting mechanism 200 is in its intermediate position approximately.

FIG. 6 depicts the cutting mechanism 200 in its end position. The window 241 previously defined between the cutting portion 220 and the anvil 242 has closed, i.e., no longer exists, due to the movement of the cutting portion 220 past the anvil 242. The dunnage 15 that was located within the window 241 has been pushed against the anvil 242 and severed by the cutting portion 220 as the cutting portion 220 advances in the cutting direction B to the position shown in FIG. 6. Thus, the portion of the dunnage 15 that advanced through the window 241 following the previous cutting cycle has been severed to form a separate piece of dunnage 15. The newly-cut piece of dunnage 15 can then exit the dunnage mechanism 60 by way of an exit 65 of the outlet chute 62. After the cutting mechanism 200 has reached the end position, the continued rotation of the crank arm 204 eventually causes the crank arm 204 to return to its home position.

Details of the cutting mechanism 200 are presented for illustrative purposes only. The jam detector 700 can be used in conjunction with other types of separators, in conjunction with cutting mechanisms other than the cutting mechanism 200, and in dunnage devices in which the dunnage is severed by means other than cutting, such as tearing, the focused application of heat, etc.

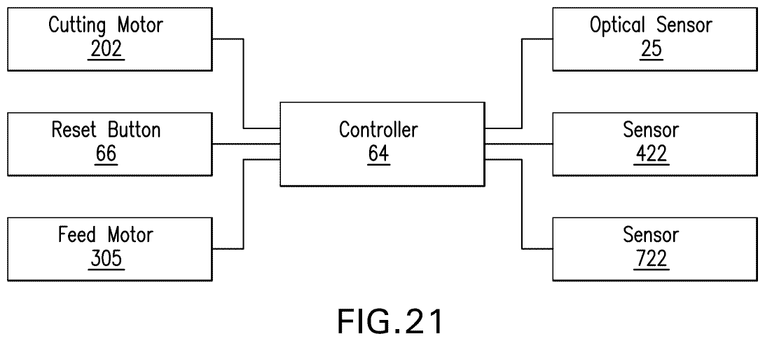

As discussed below, in the event the dunnage 15 becomes jammed in the area 500 and/or the outlet chute 62, the jam detection device 700 and/or the jam detection device 400 detect the presence of the jam, and generate an output that causes a controller 64 of the device 10 to interrupt operation of the drive assembly 600 and the cutting mechanism 200 until the jam is cleared. The controller 64 is depicted diagrammatically in FIG. 21.

The controller 64 can include a central processing unit (CPU), a system bus, a memory connected to and accessible by other portions of controller through the system bus, a system interface, and hardware entities connected to system bus. The controller 64 can be connected to as input device such as a touchscreen panel, and one or more output devices, via a wired (serial or Wired LAN) or wireless connection (e.g., a Bluetooth® connection or WiFi connection). The output devices can include, for example, one or more speakers, displays, etc. (not shown). The system interface is configured to facilitate wired or wireless communications to and from external devices, e.g., network nodes such as access points, etc.

At least some of the hardware entities perform actions involving access to and use of memory, which can be a random access memory (RAM), a disk driver, a compact disc read only memory (CD-ROM), or remote “cloud” based processing. The hardware entities can include a disk drive unit that includes a computer-readable storage medium on which is stored one or more sets of instructions, e.g., software code, configured to implement one or more of the methodologies, procedures, or functions described herein. The instructions also can reside, completely or at least partially, within the memory and/or within the CPU during execution thereof by the controller 64. The memory and the CPU also can constitute machine-readable media. The term “machine-readable media,” as used herein, refers to a single medium or multiple media (e.g., a centralized or distributed database, and/or associated caches and servers) that store the one or more sets of the instructions. The term “machine-readable media,” as used herein, also refers to any medium that is capable of storing, encoding or carrying a set of the instructions for execution by the controller 64 and that cause the controller to perform any one or more of the methodologies of the present disclosure.

The above details of the controller 64 are presented for illustrative purposes only. The controller 64 can have other configurations in alternative embodiments.

Additional details of the dunnage mechanism 60 can be found in U.S. application Ser. No. 18/340,805, the contents of which are incorporated by reference herein in their entirety.

The device 10 further includes an optical sensor 25. The optical sensor 25 is depicted in FIG. 16. The optical sensor 25 is mounted on the outlet chute 62, and is optically coupled to the interior volume 432 of the outlet chute 62 via a hole 26 in the outlet chute 62, so that the sensor 25 can detect the presence, or absence, of dunnage 15 within the interior volume 432. The sensor 25 is communicatively coupled to the controller 64. The controller 64 is configured to activate the feed motor 305 of the drive assembly 600 and the cutting motor 202 of the cutting mechanism 200 to produce another piece of dunnage 15 in the above-describe manner when the sensor 25 indicates that a piece of dunnage 15 is not present in the outlet chute 62, so that a piece of dunnage 15 is continually available to the user. Upon receiving an input from the sensor 25 indicating that a piece of dunnage 15 is present in the outlet chute 62, the controller 64 will maintain the drive assembly 600 and the cutting mechanism 200 in a deactivated state. Alternative embodiments of the device 10 can be configured without the sensor 25, and without being activated automatically upon removal of the dunnage 15 for the outlet chute 62.

The jam detector 700 is configured to detect paper jams upstream of the cutting mechanism 200 and the outlet chute 62. More specifically, the jam detector 700 is configured to detect a paper jam within an area 500 denoted in FIGS. 7-10. The area 500 represents the space within the device 10 between the exit of the rollers 610, 620 and the entrance of the cutting mechanism 200.

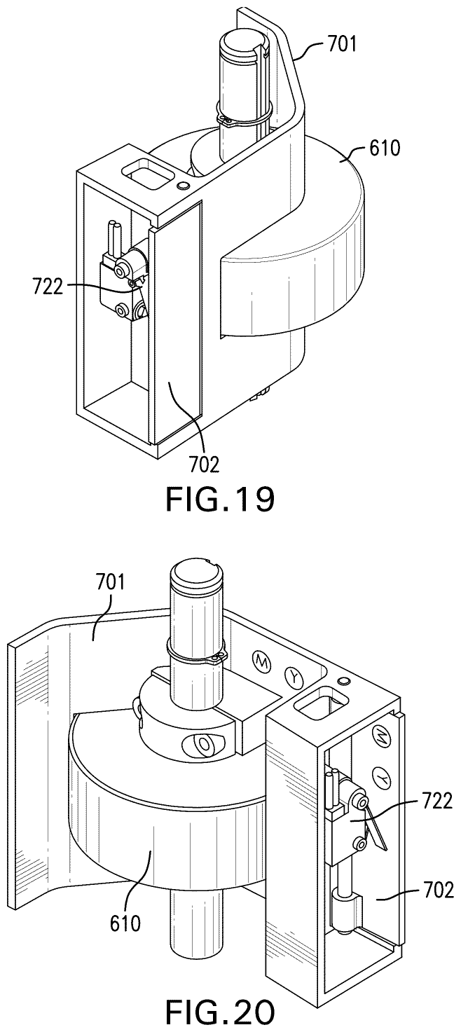

The jam detector 700 includes a guide 701, a movable member in the form of an actuator 702, and a sensor 722. The guide 701 is configured to direct the dunnage 15 along an intended path between the exit of the rollers 610, 620 and the entrance of the cutting mechanism 200. As shown in FIGS. 7-10, the guide 701 is mounted on, and fixed to the shaft 611 of the roller 610. The guide 701 thus remains stationary in relation to the rotating roller 610, and in relation to the dunnage 15 passing between the rollers 610, 620 as the dunnage 15 travels along the material path A. In alternative embodiments, a respective guide 701 can be mounted on both the roller 610 and the roller 620. Other alternative embodiments of the jam detector 700 may be configured without the guide 701. The jam detector 700 is depicted in FIGS. 19 and 20.

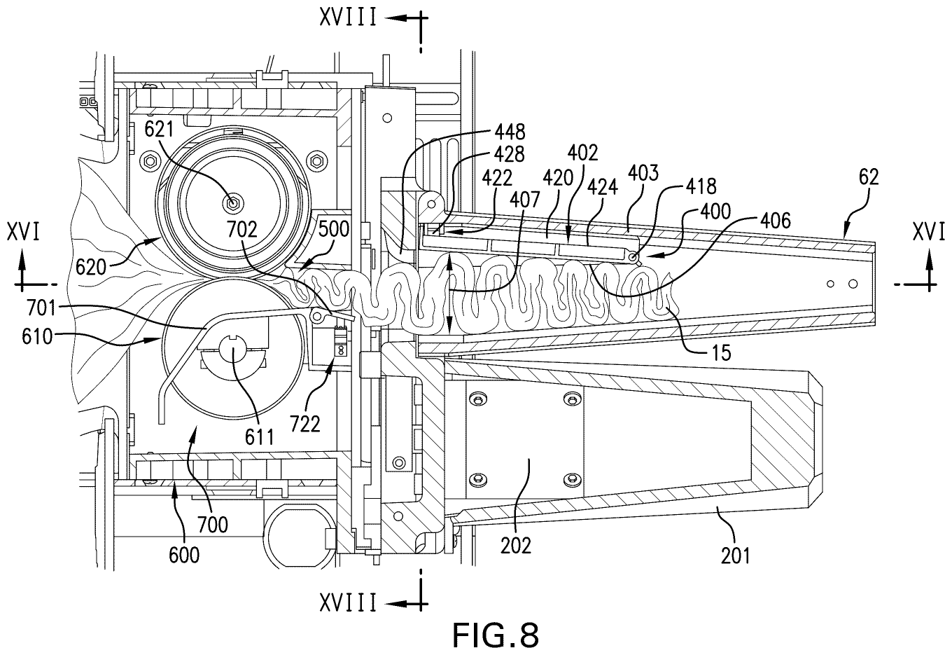

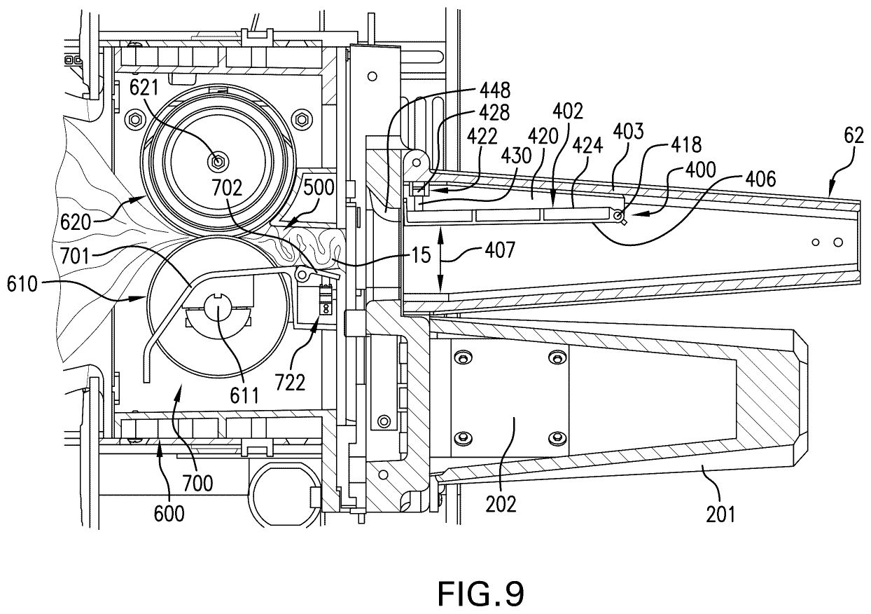

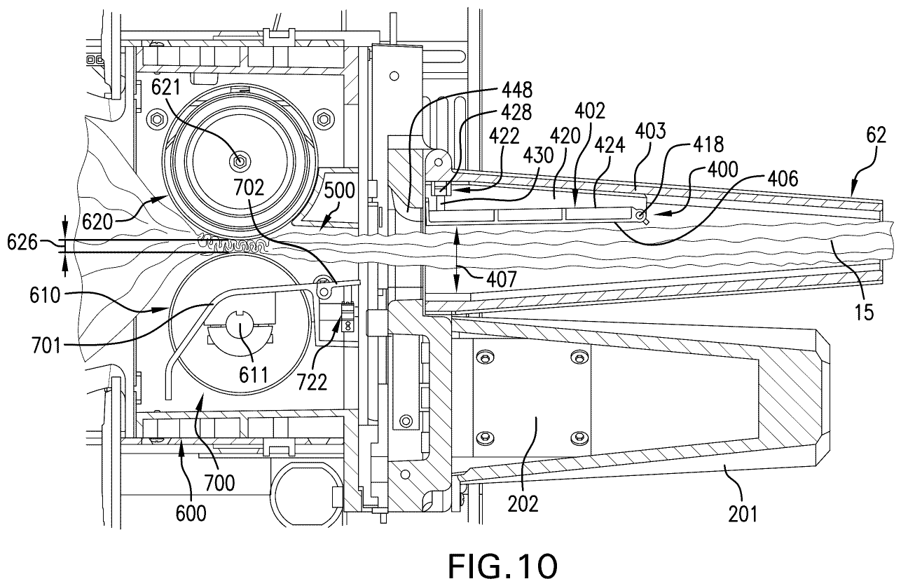

The actuator 702 is configured as a rectangular member, is mounted on the guide 701. The actuator 702 is configured to rotate in relation to the guide 701 between a first position shown in FIGS. 7 and 10, and a second position shown in FIGS. 8 and 9. The actuator 702 is biased toward its undeflected position by a spring (not shown) or other suitable technique. The actuator 702 is positioned at and near the downstream end of the guide 701, and faces the material path A so that the actuator 702 is exposed to the dunnage 15 traveling along the material path immediately downstream of the roller 610. When a jam of the dunnage 15 is not present in the area 500 and the actuator 702 is in its undeflected position, the outward-facing surface of the actuator, i.e., the surface of the actuator 702 that faces the material path A, is oriented generally parallel to the material path A.

The actuator 702 can be mounted independently of the guide 701, and can be positioned in positions other than that shown in FIGS. 7-10 in alternative embodiments. For example, the actuator 702 can be mounted on or proximate the cutting mechanism 200, such as on or proximate the anvil 242, in alternative embodiments.

The actuator 702 is operably coupled to the sensor 722 such the sensor 722 is in a first state when the actuator 702 is in its first position, and a second state when the actuator 702 is in its second position. The sensor 722 is communicatively coupled to the controller 64. The sensor 722 is configured to generate an electrical output when in its second state. As discussed below, the controller 64, upon receiving the output of the sensor 722, interrupts operation of the drive assembly 600 and the cutting mechanism 200, and prohibits re-activation of the drive assembly 600 and the cutting mechanism 200 until the controller 64 no longer receives the output of the sensor 722. The sensor 722 is configured as an electrical contact that is open when the sensor 722 is in its first state. The contact is closed when the sensor 722 is in its second state, with the closing of the contact resulting from movement of the actuator 702 to its deflected position. The closing of the contact completes an electric circuit that generates the output of the sensor 722. The sensor 722 can have other configurations in alternative embodiments. For example, the sensor 722 can be an optical sensor, a laser probe, an LVDT, an RVDT, a pressure transducer, a piezoelectric transducer etc.

When a jam of the dunnage 15 is not present in the area 500, the actuator 702 resides in its undeflected position, as shown in FIG. 7, due to the bias of the actuator 702 toward the undeflected position. In particular, when a dunnage jam is not present in the area 500, the dunnage 15 moves along the material path A between the rollers 610, 620 and the cutting mechanism 200 in a direction generally parallel to the adjacent outward-facing surface of the actuator 702. Under this condition, the dimensions of the dunnage 15 in a direction transverse to the material path A are sufficiently small so that the dunnage 15 does not exert sufficient force on the actuator 702 to move the actuator 702 to its deflected position. The actuator 702 thus remains in its undeflected position, the sensor 722 remains in its first state, and the controller 64 permits the drive assembly 600 and the cutting mechanism 200 to operate in accordance with the normal operating cycle of the device 10.

When a jam of the dunnage 15 occurs within the area 500, the dunnage 15 is forced in a direction transverse the material path A due to the continued movement of dunnage 15 into the area 500 as the rollers 610, 620 continue to rotate and force additional dunnage 15 into the area 500. The transverse displacement of the dunnage 15 can cause the jammed dunnage 15 to assume an accordion-like or zigzag pattern within the area 500 as depicted in FIG. 9, driving the dunnage 15 into contact with the actuator 702 with sufficient force to overcome the bias of the actuator 702 and move the actuator 702 from its undeflected position to its deflected position. The deflection of the actuator 702 to its deflected position closes the contacts of the sensor 722, altering the state of the sensor 722 from first to the second state. The resulting output of the sensor 722 in its second state, when received by the controller 64, causes the controller 64 to interrupt operation of the drive assembly 600 by deactivating the feed motor 305 that drives the rollers 610, 620. In addition, the controller 64, upon receiving the output of the sensor 722, prohibits operation of the cutting mechanism 200 by deactivating the cutting motor 202 that actuates the cutting portion 220 and the shuttle 230 of the cutting mechanism 200.

The device 10 is equipped with an input device in the form of, for example, a reset button 66. The reset button 66 is shown in FIG. 21 and is communicatively coupled to the controller 64. The controller 64 will prohibit the drive assembly 600 and the cutting mechanism 200 from restarting until the controller 64 no longer receives the signal from the sensor 722 indicating the presence of a paper jam in the area 500, and until the controller 64 receives an output from the reset button 66 indicating that the reset button 66 has been pressed. Alternative embodiments can be configured without an input device such as the reset button 66.

Once the operator clears the jam from the outlet chute 62 and the jammed dunnage 15 no longer exerts sufficient force on the actuator 702 to overcome the bias of the actuator 702 toward its undeflected position, the bias of the actuator 702 causes the actuator 702 to return to its undeflected position, which in turn opens the contact of the sensor 722 and alters the sensor 722 to its first state. As the controller 64 at this point no longer is receiving the output of the sensor 722 indicating the presence of a jam in the area 500, the controller 64 will permit the drive assembly 600 and the cutting mechanism 200 to be restarted once the reset button 66 is depressed. The need to press the reset button 66 before the drive assembly 600 and the cutting mechanism 200 can be reactivated can help to prevent the operator injury caused by reactivation of those components immediately following clearing of the jam by the operator, who may have their hand inserted in the material path at or near moving components of the drive assembly 600 or cutting mechanism 200, to clear the jam.

The substantially flat configuration of the actuator 702, and the substantial alignment of the inward-facing surface of the actuator with the normal direction of travel of the dunnage 15 through the area 500, allow the operator to pull the jammed dunnage 15 from the area 500 without interference from the jam detector 700.

In alternative embodiments of the device 10, the activation of only the cutting mechanism 200 may be prohibited while the controller 64 is receiving the output of the sensor 722, i.e., activation of the drive assembly 600 may be permitted when the sensor 722 is in its second state. In other alternative embodiments, the activation of only the drive assembly 600 may be prohibited while the controller 64 is receiving the output of the sensor 722, i.e., activation of the cutting mechanism 200 may be permitted when the sensor 722 is in its second state.

In alternative embodiments, the jam detector 700 can be configured so that the dunnage 15 acts directly on the sensor 722, without any intermediate structure such as the actuator 702 located between sensor 722 and the dunnage 15. For example, the sensor 722 can be configured as a pressure transducer or a piezoelectric transducer that generates an output in response to pressure exerted directly on the sensor 722 by the jammed dunnage 15. In other alternative embodiments, the sensor 722 can be configured to directly interrupt the supply of electric power to the feed motor 305 and/or the cutting mechanism 200, independent of the controller 64, when the sensor 722 registers the presence of a jam within the area 500.

In alternative embodiments, one or both of drive rollers 610, 620 can be capable of translating linearly, in a direction transverse to the material path A, to help facilitate clearing a jam of the dunnage 15 from the area 500. For example, FIG. 10 depicts the drive roller 610 after moving transversely (or downward from the perspective of FIG. 10), by a distance 626. Transverse movement of the drive roller 610 and/or the drive roller 620 can be facilitated by mounting one or both of the respective shafts 611, 621 suitable machinery or mechanisms such as linear actuators, hydraulic cylinders, spring-loaded tracks, etc. In some embodiments, the machinery or mechanisms can be integrated operationally with the controller 64 to effectuate the noted transverse movement automatically in response to the detection of the jam, and to return the roller 610 and/or the roller 620 their respective original positions once the jam has been cleared.

The downstream jam detector 400 is incorporated into the outlet chute 62. The outlet chute 62 is mounted on the dunnage mechanism 60, downstream of the cutting mechanism 200. The outlet chute 62 has a forward, or upstream end that defines an inlet of the outlet chute 62. The inlet of the outlet chute 62 is aligned with the window 241 defined by the cutting portion 220 and the anvil 242 of the cutting mechanism 200. The inlet receives the paper dunnage 15 after the dunnage 15 has been converted by the drive assembly 600, and permits the dunnage 15 to pass into an interior volume 432 of the outlet chute 62. Once the dunnage 15 has been cut by the cutting mechanism 200 as described above, the resulting piece of dunnage 15 located within the interior volume 432 can be extracted, or pulled from the outlet chute 62 by the user or an automated mechanism, by way of the exit 65 defined by a downstream end of the outlet chute 62.

As discussed below, in the event one or more of the pieces of dunnage 15 become jammed in the outlet chute 62, the jam detector 400 detects the presence of the jam and generates an output that, when received by the controller 64, causes the drive assembly 600 and the cutting mechanism 200 to cease operating until the jam is cleared, in a manner similar to that described above following detection of jam in the area 500 by the upstream jam detector 700.

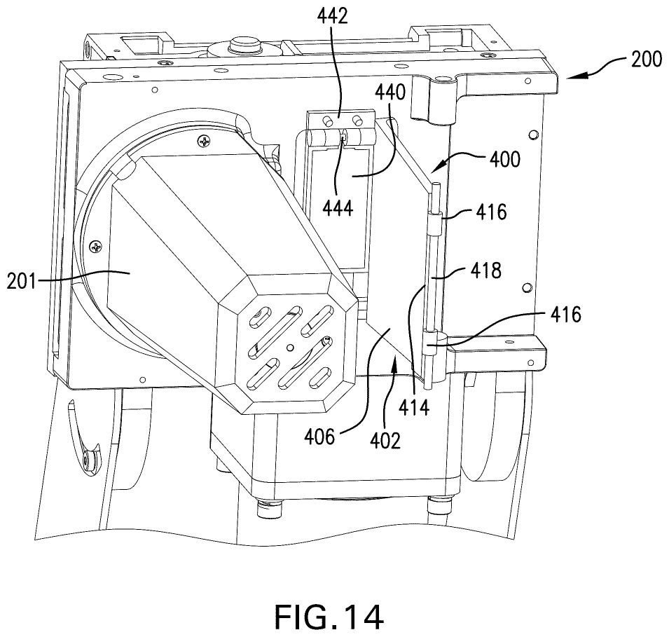

Referring to FIGS. 7-13, the jam detector 400 includes a movable member in the form of a plate or flap 402. The flap 402 is located within the interior volume 432 of the outlet chute 62. The flap 402 is mounted for rotation on an upper wall 34 and a lower wall 36 of the outlet chute 62 by way of a pin 418, as can be seen in FIG. 14. The flap 402 is located adjacent a sidewall 403 of the outlet chute 62. The flap 402 can be coupled to the outlet chute 62 using other mounting configurations in alternative embodiments.

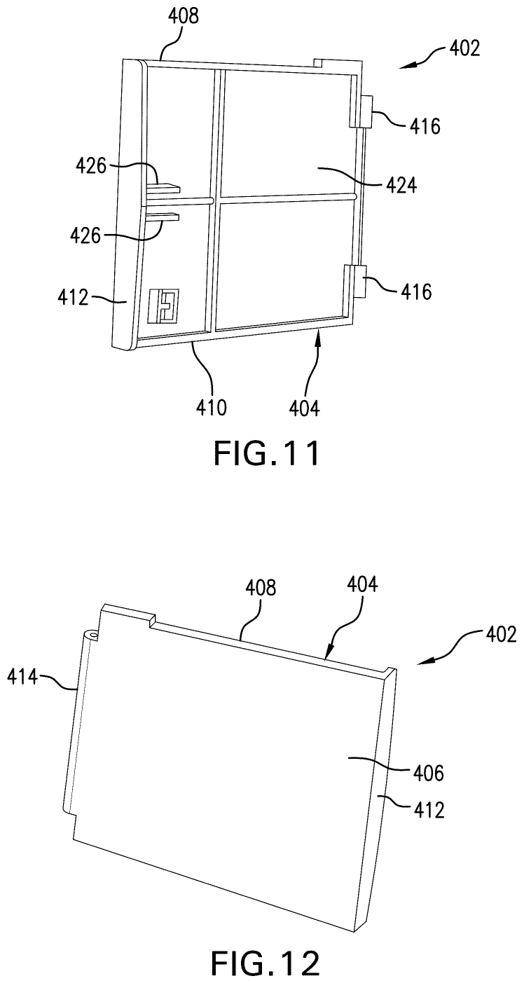

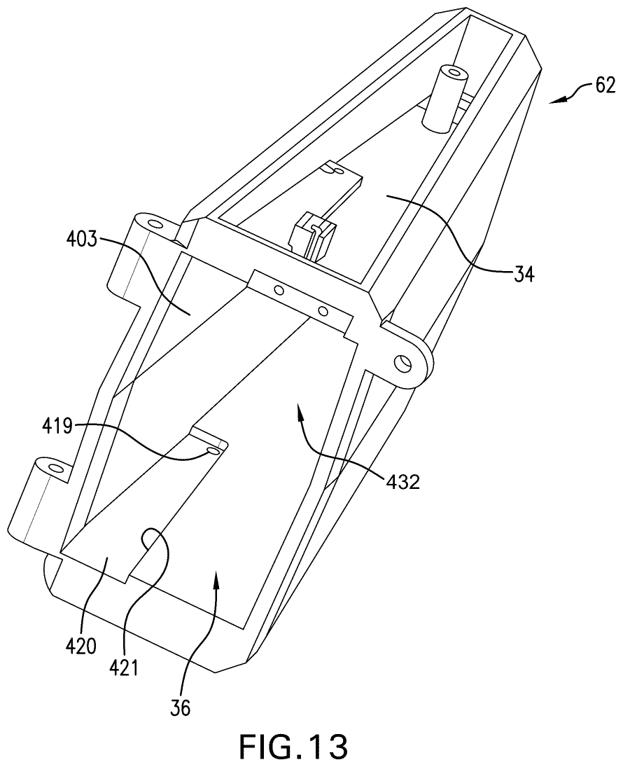

As depicted in FIGS. 11-12, the flap 402 includes a body 404. The body 404 has a substantially planar major surface 406 that faces inward, toward the centerline of the outlet chute 62. The body 404 also includes an upper edge 408 and a lower edge 410 that each adjoin the major surface 406. The upper and lower edges 408, 410 are angled downward as they extend in the downstream direction, to match the downwardly-angled geometry of the adjacent surfaces of the outlet chute 62.

The body 404 further includes an upstream edge 412 and a downstream edge 414 that each adjoin the major surface 406. The upstream edge 412 and the downstream edge 414 each have a substantially vertical orientation.

The flap 402 is configured to rotate in relation to the sidewall 403 between a first, or outward position shown in FIGS. 7, 9, and 10, and a second, or inward position shown in FIG. 8. Referring to FIGS. 7-10, the upstream end of the flap 402 is spaced from the opposite wall of the outlet chute 62 by a distance 407. The distance 407 when the flap 402 is in its inward position is less than the distance 407 when the flap 402 is in its outward position.

As can be seen in FIG. 14, the flap 402 includes two knuckles 416 that adjoin the downstream edge 414 of the body 404. The knuckles 416 are configured to receive the pin 418 with minimal clearance, so that the flap 402 can rotate smoothly on the pin 418. The ends of the pin 418 are received in respective holes 419 formed in the upper wall 34 and the lower wall 36 of the outlet chute 62. The ends of the pin 418 can be retained in the holes 419 by an interference fit or other suitable means. One of the holes 419 is visible in FIG. 13. The pin 418 has a substantially vertical orientation when installed on the outlet chute 62, so that the axis of rotation of the flap 402 is substantially vertical.

A recess 420 is formed in each of the upper wall 34 and the lower wall 36 of the outlet chute 62, as can be seen in FIG. 13. The recesses 420 face inward, toward the interior volume 432 of the outlet chute 62, and accommodate the body 404 of the flap 402 as the flap 402 rotates in relation to the outlet chute 62. The upper and lower portions of the body 404 are captured between the sidewall 403 of the outlet chute 62 and the lengthwise edges 421 of the respective recesses 420. Also, the upper edge 408 and the lower edge 410 of the body 404 are located within the respective recesses 420 in the upper wall 34 and the lower wall 36, which in turn helps to prevent the dunnage 15 from catching, or being entrained between the upper and lower edges 408, 410 and the adjacent surfaces of the outlet chute 62.

The range of rotation of the flap 402 can be, for example, about 4.5 degrees. This specific value is presented for illustrative purposes only; the range of rotation of the flap 402 can be greater, or less than about 4.5 degrees in alternative embodiments.

The disclosure of the flap 402 as the movable member is disclosed for illustrative purposes only. The movable member can have other shapes and configurations in alternative embodiments.

The jam detector 400 also includes a switch or sensor 422 mounted on the flap 402. The sensor 422 is electrically connected to the controller 64. The sensor 422 is mounted on a rear or back surface 424 of the body 404 of the flap 402, as can be seen in FIGS. 7-10. The back surface 424 is located on a side of the body 404 opposite the major surface 406. The flap 402 further includes two brackets 426 that extend from the back surface 424, as shown in FIG. 11. The brackets 426 are spaced apart, and define a space that receives the sensor 422. The sensor 422 can be securely snapped into the brackets 426. The sensor 422 can be secured to the flap 402 by other means, such as fasteners, in alternative embodiments.

Referring to FIGS. 7-10, the sensor 422 includes a body 428, and an arm 430. The arm 430 is coupled to the body 428. The arm 430 is configured to rotate in relation to the body 428 between a first, or open position shown in FIGS. 7, 9, and 10, and a second, or closed position shown in FIG. 8. The sensor 422 further includes a spring (not shown) positioned within the body 428 and configured to bias the arm 430 toward its first or open position. The bias on the arm 430 generated by the spring also biases the flap 402 toward its first or outward position. Alternative embodiments can include a separate spring to bias the flap 402 toward its outward position.

The sensor 422 further includes a throw and a contact (not shown) located within the body 428. The throw is connected to the arm 430. The throw is spaced apart from the contact when the arm 430 is in its open position. The throw is brought into physical contact with the contact when the arm 430 moved to its closed or inward position, thereby establishing electrical contact between the throw and the contact. The electrical contact between the throw and the contact when the arm 430 is in its closed position causes the sensor 422 to generate an electrical output that is sent to the controller 64.

The sensor 422 is configured so that the arm 430 is in its closed position when the flap 402 is in its inward position; and the arm 430 is in its open position when the flap 402 is in its outward position. Thus, the controller 64 is configured to interpret a state in which the controller 64 is receiving an output signal from the sensor 422 as an indication that the flap 402 is in its inward position. Conversely, the controller 64 is configured to interpret a state in which the controller 64 is not receiving an output signal from the sensor 422 as an indication that the flap 402 is in its outward position.

The sensor 422 can have configurations other than the configuration described above. For example, the sensor 422 can be an optical sensor, a laser probe, an LVDT, an RVDT, a pressure transducer, a piezoelectric transducer etc.

The jam detector 400 also includes a guide 448 mounted on the outlet chute 62, directly upstream of the upstream edge 412 of the flap 402. The guide 448 is visible in FIGS. 7-10. The guide 448 and the upstream edge 412 cooperate to inhibit cuttings and other debris from entering the cavity or volume defined by the back surface 424 of the flap 402, and the adjacent surface of the sidewall 403 of the outlet chute 62. Such debris, if allowed to enter the cavity, could interfere with the proper operation of the sensor 422.

The jam detector 400 is configured to sense a paper jam in the outlet chute 62, downstream of the cutting mechanism 200, and to generate an output that, when received by the controller 64, causes the controller 64 to interrupt operation of the drive assembly 600 and the cutting mechanism 200 until the paper jam is cleared. More specifically, the controller 64 interrupts operation of the drive assembly 600 and the cutting mechanism 200 when the flap 402 is biased toward its second or inward position, as noted above. When the paper dunnage 15 is fed into the outlet chute 62 by drive assembly 600 after being cut, the lateral or side to side dimension of the dunnage 15 is sufficiently small so that forceful contact between the dunnage 15 and the flap 402 does not occur. The flap 402 thus remains in its first or outward position; the arm 430 of the sensor 422 remains in its open position; the throw and the contact of the sensor 422 remain out of physical and electrical contact; and the controller 64 interprets the absence of an electrical signal from the sensor 422 as an indication that a paper jam is not present in the outlet chute 62.

When the paper dunnage 15 jams within the chute 62, the continued feeding of the dunnage 15 from the drive assembly 600 can force the dunnage 15 within the chute 62 to move in a transverse direction in relation to the material path, which can cause the dunnage 15 to assume an accordion-like or zigzag pattern, as depicted in FIG. 8. The transverse movement of the dunnage 15 can drive the dunnage 15 into contact the inwardly-facing major surface 406 of the flap 104 with sufficient force to cause the flap 402 to rotate to its second or outward position. The rotation of the flap 402 to its inward position causes the arm 430 to move from its open position and to its closed position, thereby establishing physical and electrical contact between the throw and the contact of the sensor 422. The resulting electrical output of the sensor 422, when received by the controller 64, causes the controller 64 to interrupt operation of the drive assembly 600 and the cutting mechanism 200.

The controller 64 will prohibit the drive assembly 600 and the cutting mechanism 200 from restarting until the controller 64 no longer receives the signal from the sensor 422 indicating the presence of a paper jam in the outlet chute 62. Once the operator clears the paper jam from the outlet chute 62 and the jammed paper dunnage 15 no longer contacts the flap 402, the outward bias of the sensor 422 on the flap 402 causes the flap 402 to return to its first or outward position, which in turn causes the throw to separate from the contact of the sensor 422. At this point, the controller 64, which no longer is receiving the output signal of the sensor 422, will permit the drive assembly 600 and the cutting mechanism 200 to resume operation once the operator presses the reset button 66. The substantially flat configuration of the flap 402, and the substantial alignment of the major surface 406 of the flap 402 with the normal direction of travel of the dunnage 15 through the outlet chute 62, allow the operator to pull the jammed dunnage 15 from the interior volume 432 of the outlet chute 62 without interference from the jam detector 400.

In alternative embodiments of the device 10, the activation of only the cutting mechanism 200 may be prohibited while the controller 64 is receiving the output signal of the sensor 422, i.e., activation of the drive assembly 600 may be permitted when the flap 402 is in its inward or outward position. In other alternative embodiments, the activation of only the drive assembly 600 may be prohibited while the controller 64 is receiving the output signal of the sensor 422, i.e., activation of the cutting mechanism 200 may be permitted when flap 402 is in its inward or outward position.

In alternative embodiments, the jam detector 400 can be configured so that the dunnage 15 acts directly on the sensor 422. For example, the sensor 422 can be configured as a pressure transducer or a piezoelectric transducer that generates an output in response to pressure exerted directly on the sensor 422 by the jammed dunnage 15. In such embodiments, the jam detector 400 can be configured without a movable member such as the flap 402. In other alternative embodiments, the sensor 422 can be configured to directly interrupt the supply of electric power to the feed motor 305 in dependent of the controller 64 when the sensor 422 registers the presence of a jam.

Additional details of the jam detector 400 can be found in U.S. application Ser. No. 18/530,186, the contents of which are incorporated by reference herein in their entirety.

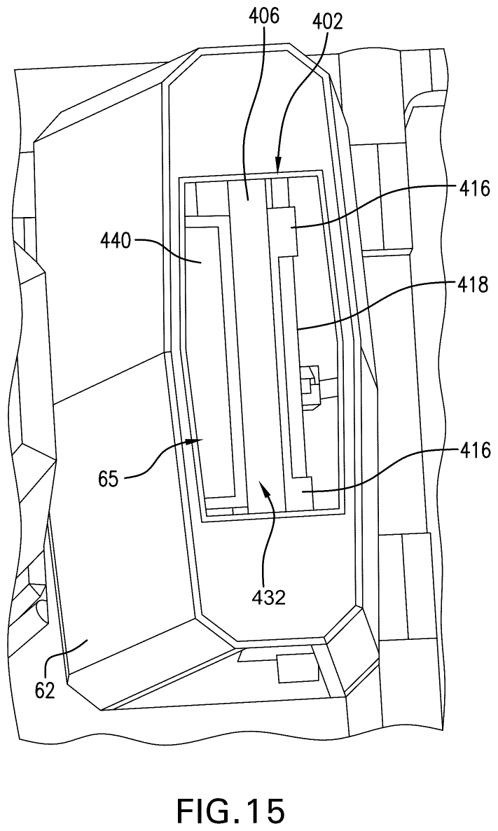

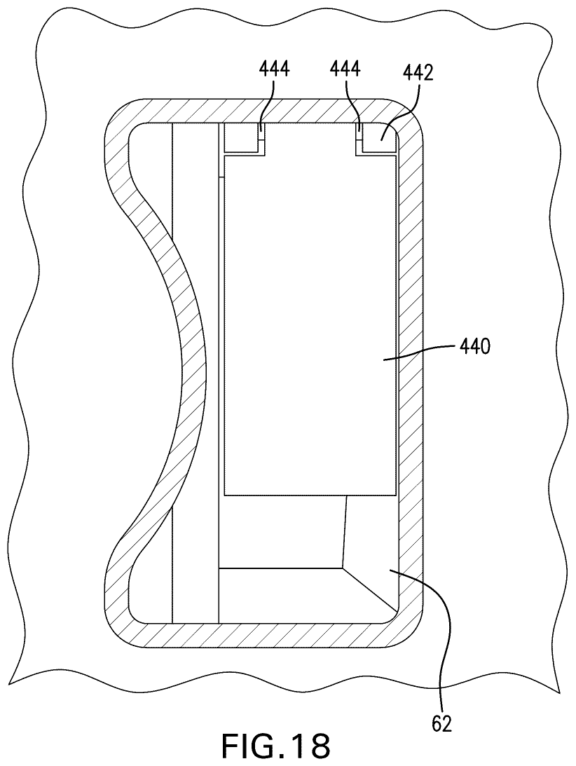

The outlet chute 62 can include a door or gate 440, shown in FIGS. 14-18. The gate 440 is suspended from a bracket 442, and is aligned with the window 241 defined between the cutting portion 220 and the anvil 242.

The gate 440 is connected to the bracket 442 by way of a pin 444 that permits the gate 440 to rotate in relation to the bracket 442. The gate 440 has a height, or vertical dimension, that is less than the height of the window 241. The gate 440 is depicted in FIGS. 14-16, and 18 in a closed position at which the gate 440 covers a portion of the inlet to the outlet chute 62.

The gate 440 is biased toward the closed position by a torsion spring (not shown) disposed around the pin 444. The bracket 442 is configured to limit rotation of the gate 440 past the closed position.

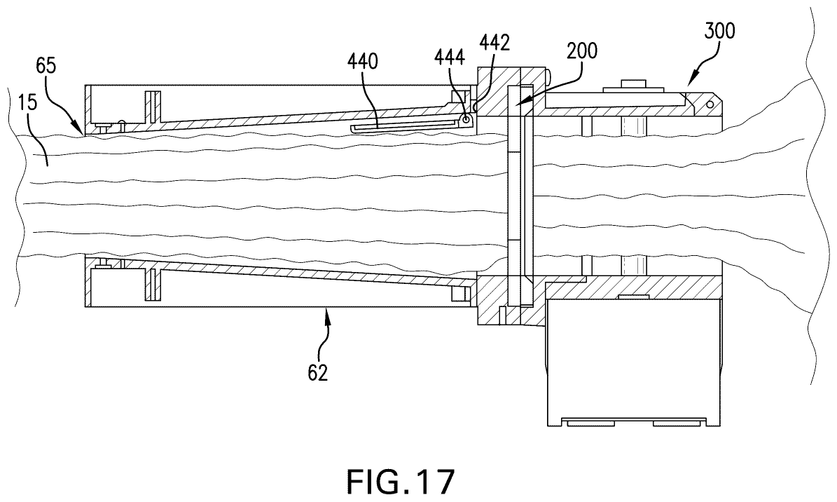

The downstream movement of the dunnage 15 into the outlet chute 62 urges the gate 440 to rotate away from its closed position, toward the interior volume 432 and against the bias of the spring, by about 90 degrees, and to an open position depicted in FIG. 17. More specifically, the downstream movement of the dunnage 15 causes the dunnage 15 to exert a drag on the gate 440, with the drag being increased by the bias exerted by the torsion spring on the gate 440. This drag rotates the gate 440 away from its closed position. When in the open position, the gate 440 does not interfere with the passage of the dunnage 15 into the interior volume 432. The bias of the spring causes the gate 440 to exert a downward force on the dunnage 15. Once the dunnage 15 has been cut by the cutting mechanism 200, the gate 440, due to its spring bias, will continue to exert a force on the dunnage 15. This force acts as a clamping force that holds the piece of dunnage 15 in place until the operator or other user pulls the downstream end of the piece of dunnage 15 to remove the piece for the outlet chute 62. Once the piece of dunnage 15 has been removed from the outlet chute 62, the gate 440 will return to its closed position under the bias of the spring. Alternative embodiments of the device 10 can be configured without the gate 440.

Jams of the dunnage 15 can occur in the area 500 without occurring simultaneously in the outlet chute 62, as shown in FIG. 9. Dunnage jams also can occur in both the area 500 and the outlet chute 62 on simultaneous basis, as shown in FIG. 8. For example, when a jam forms within the outlet chute 62, the jam may propagate in the upstream direction, towards the cutting mechanism 200 and drive assembly 600, and eventually may reach the area 500.

The use of the upstream jam detector 700 in conjunction with the downstream jam detector 400 can be particularly beneficial in situations where jams of the dunnage 15 are present in both the area 500 and the outlet chute 62, and the dunnage 15 has been cut so that the piece of dunnage 15 in the outlet chute 62 no longer is connected to the piece of dunnage 15 in the area 500. Under such circumstances, clearing the jam in the outlet chute 62 by pulling the downstream, i.e., cut, piece of dunnage 15 out of the outlet such 62 will not necessarily clear the jam in the area 500. This situation also can occur where the operator inadvertently tears the dunnage 15 when attempting to clear the jam such that the jammed dunnage 15 in the area 500 is not drawn out of the device 10 with the rest of jammed dunnage 15. Thus, without the jam detection provided by the upstream jam detector 700, the operator may be unaware that the jam still exists in the area 500 and may reactivate the drive assembly 600 of the dunnage mechanism 60 with the jam still present in the area 500, which likely will force additional dunnage 15 into the already jammed dunnage 15 and worsen the jam.

Thus, the combined use of the upstream jam detector 700 and the downstream jam detector 400 can provide the operator with a positive indication of the locations of the jam or jams with the device 10, allowing multiple jams to be cleared in one operation and without further jamming resulting from incompletely or improperly clearing the jams before restarting the device 10.

Alternative embodiments of the device 10 can be configured with the jam detector 700, and without the jam detector 400. Other alternative embodiments of the device 10 can be configured with the jam detector 400, and without the jam detector 700. Also, the jam detector 700 and the jam detector 400 can be used alone or in combination in devices for producing dunnage other than the device 10.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A device for producing dunnage, comprising:
an outlet chute configured to receive the dunnage and direct the dunnage to an exit of the device;
a drive assembly configured to deform a stock material into the dunnage and to drive the dunnage into and through the outlet chute to the exit; and
an upstream jam detector located along a material path of the dunnage between the drive assembly and the outlet chute and sensitive to detect a dunnage jam between the drive assembly and the outlet chute, wherein the upstream jam detector is associated with the drive assembly to cause the drive assembly to stop driving the dunnage into and through the outlet chute upon detection of the dunnage jam between the drive assembly and the outlet chute.

2. The device of claim 1, further comprising a controller operably connected to the drive assembly and the upstream jam detector, wherein the controller is configured to control the driving of the dunnage.

3. The device of claim 2, wherein the controller is configured to prohibit operation of the drive assembly upon detection of the dunnage jam between the drive assembly and the outlet chute is detected.

4. The device of claim 3, wherein the controller is configured to prohibit operation of the drive assembly until the dunnage jam between the drive assembly and the outlet chute is cleared as detected by the upstream jam detector.

5. The device of claim 3, further comprising a separator configured to separate a piece of the dunnage from a portion of the dunnage upstream of the separator, wherein the upstream jam detector is located upstream of the separator.

6. The device of claim 5, wherein:
the separator is operatively connected to the controller; and
the controller is configured to prohibit operation of the separator upon detection of the dunnage jam between the drive assembly and the outlet chute.

7. The device of claim 6, wherein the controller is configured to prohibit operation of the separator until the dunnage jam between the drive assembly and the outlet chute is cleared as detected by the upstream jam detector.

8. The device of claim 4, further comprising a downstream jam detector associated with the outlet chute and sensitive to detect a dunnage jam within the outlet chute, the downstream jam detector being further associated with the drive assembly to cause the drive assembly to stop driving the dunnage into and through the outlet chute upon detection of the dunnage jam within the outlet chute.

9. The device of claim 8, further comprising a separator configured to separate a piece of the dunnage from a remainder of the dunnage, wherein:
the upstream jam detector is located upstream of the separator and the downstream jam detector is located downstream of the separator; and
the upstream and downstream jam detectors are associated with the separator to cause the separator to stop separating the piece of the dunnage from the remainder of the dunnage upon detection of one or both of the dunnage jam between the drive assembly and the outlet chute and the dunnage jam within the outlet chute.

10. The device of claim 9, wherein the controller is configured to prohibit operation of the drive assembly upon detection of the dunnage jam within the outlet chute.

11. The device of claim 10, wherein the controller is configured to prohibit operation of the drive assembly until the dunnage jam within the outlet chute is cleared as detected by the downstream jam detector.

12. The device of claim 2, wherein the upstream jam detector includes a movable member having a surface exposed to a path of the dunnage, such that accumulation of the dunnage caused by the dunnage jam between the drive assembly and the outlet chute depresses the surface so that the movable member actuates a switch and/or an electrical contact communicatively coupled to the controller.

13. The device of claim 12, wherein the movable member is configured to deflect away from the material path in response to the accumulation of the dunnage.

14. The device of claim 12, wherein the surface of the movable member is substantially planar.

15. The device of claim 12, wherein the drive assembly includes a crumpler configured to deform the stock material into the dunnage.

16. The device of claim 15, wherein the crumpler includes a roller.

17. The device of claim 16, wherein:
the roller is mounted for rotation on a shaft;
the drive assembly further includes a guide configured to guide the dunnage at and near the roller;
the guide is mounted on the shaft; and
the guide includes the movable member.

18. The device of claim 16, wherein the roller is configured to translate linearly in the direction transverse to an axis of rotation thereof in response to accumulation of the dunnage caused by the dunnage jam between the drive assembly and the outlet chute.

19. A dunnage system, comprising:
a supply unit of stock material;
a supply station configured to hold the supply unit of stock material; and
the device of claim 1.

20. The system of claim 19, wherein the stock material is paper.
